(19) United States
(12) Patent Application Publication
(10) Pub. No.: US 2024/0349311 A1
(43) Pub. Date: Oct. 17, 2024

(54) METHODS AND APPARATUS FOR RESOURCE AVAILABILITY DETERMINATION

(71) Applicant: Lenovo (Beijing) Limited, Beijing (CN)

(72) Inventors: Zhennian Sun, Beijing (CN); Xiaodong Yu, Beijing (CN); Haipeng Lei, Beijing (CN); Xin Guo, Beijing (CN)

(73) Assignee: Lenovo (Beijing) Limited, Beijing (CN)

(21) Appl. No.: 18/580,266

(22) PCT Filed: Aug. 25, 2021
(86) PCT No.: PCT/CN2021/114564

§ 371 Date: Jan. 18, 2024

(51) Int. Cl. H04W 72/40; H04W 72/02; H04W 72/044

(52) U.S. Cl. CPC H04W 72/40; H04W 72/02; H04W 72/044

(57) ABSTRACT

The present disclosure relates to methods and apparatus for resource availability determination. An embodiment of the present disclosure provides an apparatus, including: a processor configured to: determine availability of one or more resources for a first sidelink transmission associated with a first radio access technology (RAT) based on at least one of: information on one or more reserved resources for second sidelink transmission(s) associated with a second RAT: information on one or more physical sidelink feedback channel (PSFCH) resources corresponding to the one or more resources: a priority level of the first sidelink transmission: a first sub-carrier spacing of the first RAT: and a first frame structure for the first RAT in one or more slots where the one or more resources are located: and a transceiver coupled to the processor and configured to not perform the first sidelink transmission with at least one resource determined as unavailable for the first sidelink transmission.

### TECHNICAL FIELD

The present disclosure relates to sidelink communication, and more specifically relates to methods and apparatus for resource availability determination when different radio access technologies (RATs) coexist.

### BACKGROUND OF THE INVENTION

In the 3rd Generation Partnership Project (3GPP) Release 16, Long Term Evolution (LTE) vehicle to everything (V2X) and New Radio (NR) V2X are designed to coexist in different channels (e.g., in different bands or adjacent channels), and priority-based solutions are designed for in-device coexistence between LTE V2X and NR V2X.

However, dedicated V2X spectrum is scarce in some regions, and LTE V2X and NR V2X may need to coexist in the same channel. On co-channel coexistence of LTE V2X and NR V2X, the design principle is that no change should be made to LTE V2X. Therefore, improved solutions for resource availability determination for NR V2X are desired.

### SUMMARY

An embodiment of the present disclosure provides an apparatus, including: a processor configured to: determine availability of one or more resources for a first sidelink transmission associated with a first RAT based on at least one of: information on one or more reserved resources for second sidelink transmission(s) associated with a second RAT; information on one or more physical sidelink feedback channel (PSFCH) resources corresponding to the one or more resources; a priority level of the first sidelink transmission; a first sub-carrier spacing of the first RAT; and a first frame structure for the first RAT in one or more slots where the one or more resources are located; and a transceiver coupled to the processor and configured to not perform the first sidelink transmission with at least one resource determined as unavailable for the first sidelink transmission.

In some embodiments of the present disclosure, in order to determine the availability of the one or more resources, the processor is configured to: determine a first resource of the one or more resources as unavailable for the first sidelink transmission when the first resource at least partially overlaps with any of the one or more reserved resources associated with the second RAT in both time domain and frequency domain or a PSFCH resource corresponding to the first resource at least partially overlaps with any of the one or more reserved resources associated with the second RAT in both time domain and frequency domain. Besides considering the resource overlapping, the measured sidelink reference signal received power (RSRP) may be also considered, e.g., when the measured sidelink RSRP of the second RAT is above an RSRP threshold, the one or more resources are determined as unavailable.

In some embodiments of the present disclosure, in order to determine the availability of the one or more resources, the processor is configured to: in the case that the priority level of the first sidelink transmission is higher than a configured level, determine a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both time domain and frequency domain; and in the case that the priority level of the first sidelink transmission is lower than or equal to the configured level, determine the first resource as unavailable for the first sidelink transmission when the first resource at least partially overlaps with any of the one or more reserved resources associated with the second RAT in both time domain and frequency domain. Besides considering the resource overlapping, the measured sidelink RSRP may be also considered, e.g., when the measured sidelink RSRP of the second RAT is above an RSRP threshold, the one or more resources are determined as unavailable.

In some embodiments of the present disclosure, in order to determine the availability of the one or more resources, the processor is configured to: determine a first resource of the one or more resources as unavailable for the first sidelink transmission when any resource in the slot in which the first resource is located or a PSFCH resource corresponding to any resource in the slot in which the first resource is located is reserved for the second sidelink transmission(s) associated with the second RAT.

In some embodiments of the present disclosure, the processor is further configured to: select a resource from resource(s) determined as available for the first sidelink transmission; determine whether the selected resource is available based on information on one or more reserved resources for sidelink transmission(s) associated with the second RAT; and perform resource reselection when the selected resource is determined as unavailable.

In some embodiments of the present disclosure, the selected resource is determined as unavailable when the selected resource at least partially overlaps with any of the one or more reserved resources in both time domain and frequency domain, and/or a PSFCH resource corresponding to the selected resource at least partially overlaps with any of the one or more reserved resources in both time domain and frequency domain.

In some embodiments of the present disclosure, the selected resource is determined as unavailable when any resource in the slot in which the selected resource is located or a PSFCH resource corresponding to any resource in the slot in which the selected resource is located is reserved for the sidelink transmission(s) associated with the second RAT.

Another embodiment of the present disclosure provides a method, including: determining availability of one or more resources for a first sidelink transmission associated with a first RAT based on at least one of: information on one or more reserved resources for second sidelink transmission(s) associated with a second RAT; information on one or more PSFCH resources corresponding to the one or more resources; a priority level of the first sidelink transmission; a first sub-carrier spacing of the first RAT; and a first frame structure for the first RAT in one or more slots where the one or more resources are located; and not performing the first sidelink transmission with at least one resource determined as unavailable for the first sidelink transmission.

In some embodiments of the present disclosure, determining the availability of the one or more resources includes: determining a first resource of the one or more resources as unavailable for the first sidelink transmission when the first resource at least partially overlaps with any of the one or more reserved resources associated with the second RAT in both time domain and frequency domain or a PSFCH resource corresponding to the first resource at least partially overlaps with any of the one or more reserved resources associated with the second RAT in both time domain and frequency domain.

In some embodiments of the present disclosure, determining the availability of the one or more resources includes: in the case that the priority level of the first sidelink transmission is higher than a configured level, determining a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both time domain and frequency domain; and in the case that the priority level of the first sidelink transmission is lower than or equal to the configured level, determining the first resource as unavailable for the first sidelink transmission when the first resource at least partially overlaps with any of the one or more reserved resources associated with the second RAT in both time domain and frequency domain.

In some embodiments of the present disclosure, determining the availability of the one or more resources includes: determining a first resource of the one or more resources as unavailable for the first sidelink transmission when any resource in the slot in which the first resource is located or a PSFCH resource corresponding to any resource in the slot in which the first resource is located is reserved for the second sidelink transmission(s) associated with the second RAT.

In some embodiments of the present disclosure, the method further includes: selecting a resource from resource(s) determined as available for the first sidelink transmission; determining whether the selected resource is available based on information on one or more reserved resources for sidelink transmission(s) associated with the second RAT; and performing resource reselection when the selected resource is determined as unavailable.

In some embodiments of the present disclosure, the selected resource is determined as unavailable when the selected resource at least partially overlaps with any of the one or more reserved resources in both time domain and frequency domain, and/or a PSFCH resource corresponding to the selected resource at least partially overlaps with any of the one or more reserved resources in both time domain and frequency domain.

In some embodiments of the present disclosure, the selected resource is determined as unavailable when any resource in the slot in which the selected resource is located or a PSFCH resource corresponding to any resource in the slot in which the selected resource is located is reserved for the sidelink transmission(s) associated with the second RAT.

### BRIEF DESCRIPTION OF THE DRAWINGS

FIG. 1 illustrates a schematic diagram of an exemplary wireless communication system according to some embodiments of the present disclosure.

FIG. 2A illustrates an exemplary resource selection procedure according to some embodiments of the present disclosure.

FIG. 2B illustrates an exemplary resource reselection procedure according to some embodiments of the present disclosure.

FIGS. 3A-3G illustrate some examples for resource availability determination according to some embodiments of the present disclosure.

FIG. 4A illustrates an exemplary frame structure of LTE V2X according to some embodiments of the present disclosure.

FIG. 4B and 4C illustrate exemplary frame structures of NR V2X according to some embodiments of the present disclosure.

FIGS. 5A-5D illustrate some exemplary frames structures of simultaneous NR V2X and LTE V2X transmissions according to some embodiments of the present disclosure.

FIG. 6A illustrates an exemplary re-evaluation procedure according to some embodiments of the present disclosure.

FIG. 6B illustrates an exemplary pre-emption checking procedure according to some embodiments of the present disclosure.

FIG. 7 illustrates a simplified block diagram of an exemplary apparatus according to some embodiments of the present disclosure.

FIG. 8 illustrates a flow chart of an exemplary method according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that not all illustrated operations need be performed, for example, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Embodiments of the present application may be provided in a network architecture that adopts various service scenarios, for example but not limited to, 3GPP 3G, LTE, LTE-Advanced (LTE-A), 3GPP 4G, 3GPP 5G NR, 3GPP Release 16 and onwards, etc. It is contemplated that along with the 3GPP and related communication technology development, the terminologies recited in the present application may change, which should not affect the principle of the present application.

Embodiments of the present application may relate to coexistence between LTE V2X and NR V2X. It is contemplated that all embodiments in the present application are also applicable to similar technical problems in coexistence between other different RATs.

User equipment (UE) under NR V2X scenario and/or LTE V2X scenario may be referred to as V2X UE(s). A V2X UE which transmits data on sidelink may be referred to as a UE for transmitting, a transmitting UE, a transmitting V2X UE, a Tx UE, a V2X Tx UE, a sidelink (SL) Tx UE, or the like. A V2X UE which receives data on sidelink may be referred to as a UE for receiving, a receiving UE, a receiving V2X UE, an Rx UE, a V2X Rx UE, an SL Rx UE, or the like.

V2X UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present application, V2X UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present application, V2X UE(s) may include wearable devices, such as smart watches, fitness bands, optical head-mounted displays, or the like. Moreover, V2X UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. V2X UE(s) may communicate directly with BS(s) via communication signals.

A BS under NR V2X scenario and/or LTE V2X scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

A BS may serve a number of V2X UEs within a serving area, for example, a cell or a cell sector via a wireless communication link. A BS may communicate directly with one or more V2X UEs via communication signals. For example, a BS may serve V2X UEs within a macro cell.

Sidelink communication between a Tx UE and an Rx UE under NR V2X scenario includes groupcast communication, unicast communication, or broadcast communication.

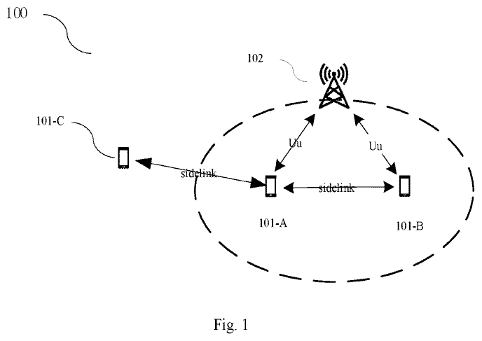

FIG. 1 illustrates an exemplary wireless communication system (e.g., a V2X communication system) 100 in accordance with some embodiments of the present application.

As shown in FIG. 1, the V2X communication system 100 includes a base station, i.e., BS 102, and some V2X UEs, i.e., UE 101-A, UE 101-B, and UE 101-C. The UE 101-A and the UE 101-B are within the coverage of the BS 102, and the UE 101-C is outside the coverage of the BS 102. The UE 101-A, the UE 101-B, and the UE 101-C may perform sidelink unicast transmission, sidelink groupcast transmission, or sidelink broadcast transmission. It is contemplated that, in accordance with some other embodiments of the present application, a V2X communication system may include more BSs and more or fewer V2X UEs.

In addition, although the V2X UE as shown in FIG. 1 is illustrated in the shape of a cellphone, it is contemplated that a V2X communication system may include any type of UE (e.g., a roadmap device, a cell phone, a computer, a laptop, IoT device or other type of device) in accordance with some other embodiments of the present disclosure.

According to some embodiments of FIG. 1, the UE 101-A may function as a Tx UE, and the UE 101-B and the UE 101-C may function as Rx UEs. The UE 101-A may exchange V2X messages with the UE 101-B or the UE 101-C through a sidelink using the NR technology, or the LTE technology, through PC5 interface as defined in 3GPP TS 23.303. The UE 101-A may transmit information or data to other UE(s) within the V2X communication system through sidelink unicast, sidelink groupcast, or sidelink broadcast. For instance, the UE 101-A may transmit data to the UE 101-B in a sidelink unicast session. The UE 101-A may transmit data to the UE 101-B and the UE 101-C in a groupcast group by a sidelink groupcast transmission session. Also, the UE 101-A may transmit data to the UE 101-B and the UE 101-C by a sidelink broadcast transmission session.

Alternatively, according to some other embodiments of FIG. 1, the UE 101-B or the UE 101-C may function as a Tx UE and transmit V2X messages, and the UE 101-A may function as an Rx UE and receive the V2X messages from the UE 101-B or the UE 101-C.

Both the UE 101-A and the UE 101-B in the embodiments of FIG. 1 may transmit information to the BS 102 and receive control information from the BS 102, for example, via NR Uu interface. The BS 102 may define one or more cells, and each cell may have a coverage area. As shown in FIG. 1, both the UE 101-A and the UE 101-B are within the coverage of the BS 102, while the UE 101-C is not.

The BS 102 as illustrated and shown in FIG. 1 is not a specific base station, but may be any base station(s) in the V2X communication system. For example, if the V2X communication system includes two BSs 102, the UE 101-A being within a coverage area of any one the two BSs 102 may be called as a case that the UE 101-A is within a coverage of BS 102 in the V2X communication system; and only the UE 101-A being outside of coverage area(s) of both BSs 102 can be called as a case that the UE 101-A is outside of the coverage of BS 102 in the V2X communication system.

In the present disclosure, a UE may simultaneously perform transmission or reception using two or more RATs, for example, NR and E-UTRA (i.e. LTE), etc. The present disclosure describes embodiments in which a UE simultaneously performs transmission or reception using NR and LTE, and it should be noted that the solutions also apply to other types of RATs.

Priority-based solutions are designed for in-device coexistence between LTE V2X and NR V2X. In some cases, a UE would transmit a first channel or signal using LTE radio access, and transmit second channels or signals using NR radio access. If the transmission of the first channel or signal would overlap in time with a transmission of the second channels or signals, and the priorities of the channels or signals are known to both LTE radio access and NR radio access at the UE T milliseconds prior to the start of the earliest of the two transmissions (where T≤4 and is based on UE implementation), the UE may transmit only the channel(s) or signal(s) of the RAT with the highest priority. The priorities of the channels or signals may be determined by the sidelink control information (SCI) formats scheduling the transmissions of the channels or signals. In the case of a sidelink synchronization signal (S-SS) or physical sidelink broadcast channel (PSBCH) block or a sidelink synchronization signal using LTE radio access, the priority thereof is indicated by higher layers. In the case of a physical sidelink shared channel (PSFCH), the priority thereof is equal to the priority of the corresponding physical sidelink shared channel (PSSCH).

In some other cases, a UE would respectively transmit or receive a first channel or signal using LTE radio access and receive a second channel or signal or transmit second channels or signals using NR radio access. If a transmission or reception of the first channel or signal would respectively overlap in time with a reception of the second channel or signal or transmission of the second channels or signals, and the priorities of the channels or signals are known to both LTE radio access and NR radio access at the UE T milliseconds prior to the start of the earliest transmission or reception (where T≤4 and is based on UE implementation), the UE may transmit or receive only the channel(s) or signal(s) of the RAT with the highest priority. The priorities of the channels or signals may be determined by the SCI formats scheduling the transmissions of the channels or signals. In the case of an S-SS or PSBCH block or a sidelink synchronization signal using LTE radio access, the priority thereof is indicated by higher layers. In the case of a PSFCH, the priority thereof is equal to the priority of the corresponding PSSCH.

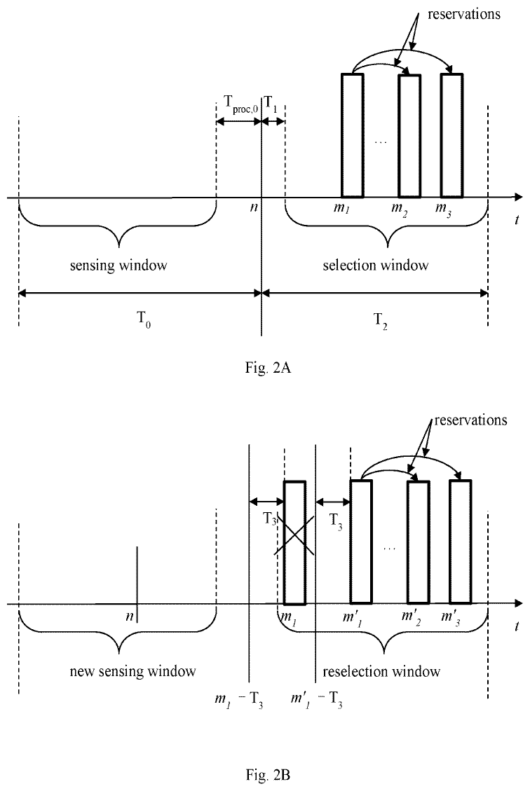

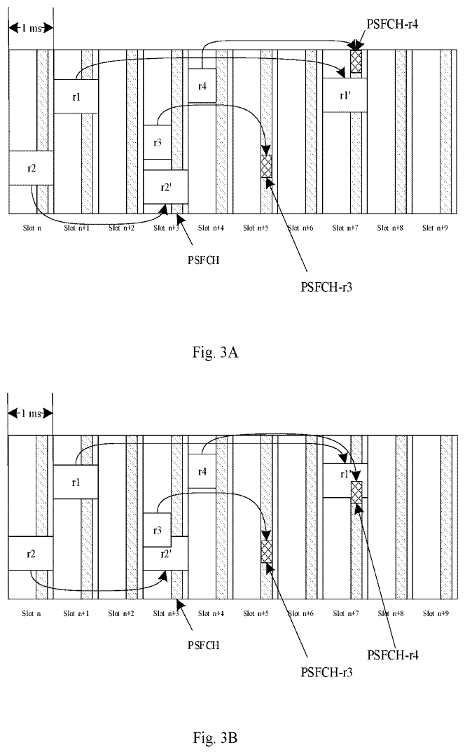

A UE may perform a resource selection procedure to select and/or reserve resource(s) for sidelink transmission. FIG. 2A illustrates an exemplary resource selection procedure according to some embodiments of the present disclosure. In FIG. 2A, T₀ is a configured or pre-configured parameter which equals a size of a sensing window plus an interval T_{proc,0}, which represents a time interval for processing information sensed in the sensing window, n represents the time when resource selection is triggered, T₁ represents the time interval for reporting the sensed information to a higher layer and processing time of resource selection, and T₂ equals T₁ plus a size of a selection window.

When resource selection is triggered at time n, the UE shall determine the set of resources (which are, for example, the resources located at m₁, m₂, m₃ in the selection window by its implementation) to be reported to higher layers and reserved for PSSCH transmission. In the time period from n−T₀ to n−T_{proc,0}, the UE performs sensing, and in the period from n−T_{proc,0} to n, the UE processes information sensed in the sensing window to determine which resource(s) is (are) selectable. In the resource at m₁, the UE further makes reservations to reserve the next one or more resources, e.g., resources at m₂, m₃.

FIG. 2B illustrates an exemplary resource reselection procedure according to some embodiments of the present disclosure.

In FIG. 2B, resource selection is triggered at time n, and the first reserved resource is located at time m₁. The re-evaluation cut-off time is m₁−T₃, that is, the UE re-evaluates the resources until m₁−T₃. At time m₁−T₃, the UE determines that the reserved resource mi is no longer available based on information sensed in a new sensing window. The UE then reselects a resource in a reselection window, e.g., the resource at time m′₁. Also, resources at m′₂, m′₃ can be reserved. The new re-evaluation cut-off time becomes m′₁−T₃.

According to some embodiments of the present disclosure, a UE may perform resource selection for a sidelink transmission associated with a first RAT (e.g., NR) based on a sensing result of a second RAT (e.g., LTE).

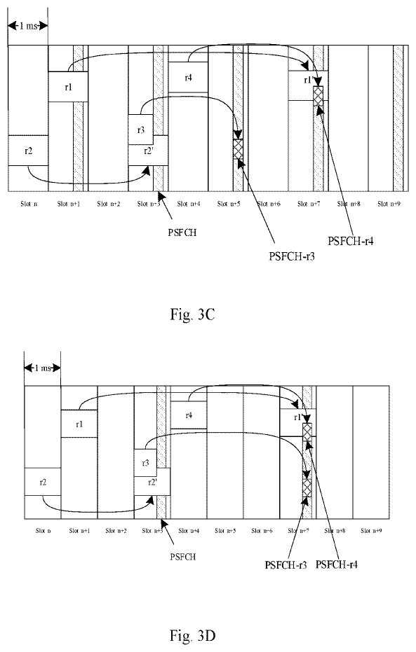

FIGS. 3A-3G illustrate some examples for resource availability determination according to some embodiments of the present disclosure.

In FIGS. 3A-3G, there are ten slots, i.e., slot n, slot n+1, slot n+2, slot n+3, slot n+4, slot n+5, slot n+6, slot n+7, slot n+8, and slot n+9. Some of the slots include a box with right slash, which represents a set of PSFCH resources. For example, in slot n+3, the set of PSFCH resources are marked by an arrow with the explanation note “PSFCH”. Some slots include reserved resources for LTE transmissions or receptions (e.g., r1, r2, r1′, and r2′). Some PSFCH resources include a box with cross lines, which refers to a PSFCH resource associated with or corresponding to a resource for NR transmission. For example, the box marked by the arrow with the explanation note “PSFCH-r3” represents the corresponding PSFCH resource associated with resource r3. The sub-carrier spacing (SCS) for LTE V2X is 15 kHz, and the SCS for NR V2X may be 15 kHz or 30 KHz.

In the example shown in FIG. 3A, some parameters for LTE V2X and NR V2X are presented as follows:

parameters

| HARQ feedback | enabled | |
|---|---|---|
| SCS for NR V2X | 15 | kHz |
| period of PSFCH | 1 | slot |
| length of a slot for | 1 | ms |
| LTE V2X | | |
| length of a slot for | 1 | ms |
| NR V2X | | |

Resource r1 (in slot n+1) and resource r2 (in slot n) are resources reserved for LTE sidelink transmissions, resource r1 reserves resource r1′ (in slot n+7), and resource r2 reserves resource r2′ (in slot n+3). It is to be determined whether resource r3 (in slot n+3) and resource r4 (in slot n+4) are available for NR sidelink transmission in this example. According to the frame structure of a slot of NR V2X, in each slot, the resources for carrying data start from the first symbol in the slot and end before PSFCH. As shown in FIG. 3A, resource r3 starts from the beginning of slot n+3, and ends before PSFCH in slot n+3.

The PSFCH resource marked by the explanatory note “PSFCH-r3” (in slot n+5) is the corresponding PSFCH resource for resource r3, and the PSFCH resource marked by the explanatory note “PSFCH-r4” (in slot n+7) is the corresponding PSFCH resource for resource r4.

According to some embodiments of the present disclosure, in order to determine availability of a particular resource for NR sidelink transmission, a UE may check whether the particular resource overlaps or partially overlaps with any resource reserved for LTE sidelink transmission. In some scenarios, when hybrid automatic repeat request (HARQ) feedback is enabled for NR sidelink transmission, the UE may further check whether the PSFCH resource associated with the particular resource, which is used for transmitting the HARQ feedback, overlaps or partially overlaps with any resource reserved for LTE sidelink transmission.

In conclusion, there are two scenarios regarding the HARQ feedback, the first is: HARQ feedback being disabled, and the second is: HARQ feedback being enabled.

For scenario 1: the UE only checks the following condition:
1) whether the particular resource overlaps or partially overlaps with any resource reserved for LTE sidelink transmission.

For scenario 2: the UE may check the following two conditions:
1) whether the particular resource overlaps or partially overlaps with any resource reserved for LTE sidelink transmission; and
2) whether the associated PSFCH resource overlaps or partially overlaps with any resource reserved for LTE sidelink transmission.

For example, in the case that HARQ feedback is disabled, the UE may check whether a particular resource at least partially overlaps with any resource reserved for LTE sidelink transmission in both time domain and frequency domain. When the particular resource at least partially overlaps with a resource reserved for LTE sidelink transmission in both time domain and frequency domain, the UE may determine the particular resource as unavailable for NR sidelink transmission and excludes it from candidate resource(s) for NR sidelink transmission. When the particular resource does not at least partially overlaps with any resource reserved for LTE sidelink transmission in both time domain and frequency domain, the particular resource is not excluded from candidate resource(s) for NR sidelink transmission according to this resource availability determination. It should be noted that the UE may need to further determine whether the particular resource is selectable for NR sidelink transmission according to other conditions although it is not excluded for overlapping with a resource reserved for LTE sidelink transmission.

In the example of FIG. 3A, HARQ feedback is enabled. For resource r3, which has an associated PSFCH resource, i.e. PSFCH-r3, the UE may check two conditions:
1) whether resource r3 overlaps or partially overlaps with any resource reserved for LTE sidelink transmission; and
2) whether resource PSFCH-r3 overlaps or partially overlaps with any resource reserved for LTE sidelink transmission.

In this example, resource r3 does not overlap with any resource reserved for LTE sidelink transmission and resource PSFCH-r3 also does not overlap with any resource reserved for LTE sidelink transmission. Thus, resource r3 is not excluded from candidate resource(s) for NR sidelink transmission according to this resource availability determination. The UE may determine the availability of resource r4 in a similar fashion. Still, it should be noted that the UE may need to further determine whether resources r3 and r4 are selectable for NR sidelink transmission according to other conditions although resources r3 and r4 are not excluded based on the above two conditions.

In some embodiments, the resource availability determination in scenario 2 is further based on the priority level of the NR V2X transmission. For example, a priority level threshold may be configured, preconfigured, determined by a BS, by pre-configuration or by the specification. If the priority level of an NR V2X transmission is higher than the priority level threshold, the UE may further consider whether the associated PSFCH resource for this NR V2X transmission at least partially overlaps with any resource reserved for LTE sidelink transmission. If the priority level of the NR V2X transmission is lower than or equal to the priority level threshold, the UE may only check whether the particular resource at least partially overlaps with any resource reserved for LTE sidelink transmission.

Take resource r3 in FIG. 3A as an example, when the NR V2X transmission has a priority level higher than the priority level threshold, the UE may first check whether resource r3 overlaps or partially overlaps with any resource reserved for LTE sidelink transmission; if not, the UE may further check whether resource PSFCH-r3 overlaps or partially overlaps with any resource reserved for LTE sidelink transmission. When the NR V2X transmission has a priority level lower than or equal to the priority level threshold, the UE only checks whether resource r3 overlaps or partially overlaps with any resource reserved for LTE sidelink transmission, and does not check whether resource PSFCH-r3 overlaps or partially overlaps with any resource reserved for LTE sidelink transmission.

FIG. 3B illustrates another example for resource availability determination according to some embodiments of the present disclosure.

In FIG. 3B, some parameters are presented as follows:

parameters

| HARQ feedback | enabled | |
|---|---|---|
| SCS for NR V2X | 15 | kHz |
| period of PSFCH | 1 | slot |
| length of a slot for | 1 | ms |
| LTE V2X | | |
| length of a slot for | 1 | ms |
| NR V2X | | |

Resource r1 and resource r2 are resources reserved for LTE sidelink transmissions, resource r1 reserves resource r1′, and resource r2 reserves resource r2′. It is to be determined whether resource r3 and resource r4 are available for NR sidelink transmission in this example. Resource r3 has a corresponding PSFCH resource, i.e. PSFCH-r3, and resource r4 has a corresponding PSFCH resource, i.e. PSFCH-r4.

Resource r3 partially overlaps with resource r2′, which is reserved for LTE sidelink transmission. Therefore, resource r3 is considered as unavailable for NR sidelink transmission.

Resource r4 does not overlap with any resource reserved for LTE sidelink transmission, while the corresponding PSFCH resource, i.e. PSFCH-r4, partially overlaps with resource r1′, which is reserved for LTE sidelink transmission. Therefore, resource r4 is also considered as unavailable for NR sidelink transmission.

In some embodiments, when the priority level of the NR sidelink transmission is lower than or equal to a priority level threshold, the UE does not check whether PSFCH-r4 overlaps or partially overlaps with any resource reserved for LTE sidelink transmission. In this case, resource r4 is not excluded according to this resource availability determination.

FIG. 3C illustrates another example for resource availability determination according to some embodiments of the present disclosure.

In FIG. 3C, some parameters are presented as follows:

parameters

| HARQ feedback | enabled | |
|---|---|---|
| SCS for NR V2X | 15 | kHz |
| period of PSFCH | 2 | slots |
| length of a slot for | 1 | ms |
| LTE V2X | | |
| length of a slot for | 1 | ms |
| NR V2X | | |

Based on the similar availability determination manner as described above, resource r3 partially overlaps with resource r2′, which is reserved for LTE sidelink transmission, and thus resource r3 is considered as unavailable for NR sidelink transmission.

Resource r4 does not overlap with any resource reserved for LTE sidelink transmission, while the corresponding PSFCH resource, i.e. PSFCH-r4, partially overlaps with resource r1′, which is reserved for LTE sidelink transmission. Therefore, resource r4 is also considered as unavailable for NR sidelink transmission.

In some embodiments, when the priority level of the NR sidelink transmission is lower than or equal to a priority level threshold, the UE does not check whether PSFCH-r4 overlaps or partially overlaps with any resource reserved for LTE sidelink transmission. In this case, resource r4 is not excluded according to this resource availability determination.

FIG. 3D illustrates another example for resource availability determination according to some embodiments of the present disclosure.

In FIG. 3D, some parameters are presented as follows:

parameters

| HARQ feedback | enabled | |
|---|---|---|
| SCS for NR V2X | 15 | kHz |
| period of PSFCH | 4 | slots |
| length of a slot for | 1 | ms |
| LTE V2X | | |
| length of a slot for | 1 | ms |
| NR V2X | | |

Based on the similar availability determination manner as described above, resource r3 partially overlaps with resource r2′, which is reserved for LTE sidelink transmission, and thus resource r3 is considered as unavailable for NR sidelink transmission.

Resource r4 does not overlap with any resource reserved for LTE sidelink transmission, while the corresponding PSFCH resource, i.e. PSFCH-r4, partially overlaps with resource r1′, which is reserved for LTE sidelink transmission. Therefore, resource r4 is also considered as unavailable for NR sidelink transmission.

In some embodiments, when the priority level of the NR sidelink transmission is lower than or equal to a priority level threshold, the UE does not check whether PSFCH-r4 overlaps or partially overlaps with any resource reserved for LTE sidelink transmission. In this case, resource r4 is not excluded according to this resource availability determination.

FIG. 3E illustrates another example for resource availability determination according to some embodiments of the present disclosure.

In FIG. 3E, some parameters are presented as follows:

parameters

| HARQ feedback | enabled | |
|---|---|---|
| SCS for NR V2X | 30 | kHz |
| period of PSFCH | 1 | slots |
| length of a slot for | 1 | ms |
| LTE V2X | | |
| length of a slot for | 0.5 | ms |
| NR V2X | | |

Based on the similar availability determination manner as described above, resource r3 partially overlaps with resource r2′, which is reserved for LTE sidelink transmission, and thus resource r3 is considered as unavailable for NR sidelink transmission.

Resource r4 does not overlap with any resource reserved for LTE sidelink transmission, while the corresponding PSFCH resource, i.e. PSFCH-r4, partially overlaps with resource r1′, which is reserved for LTE sidelink transmission. Therefore, resource r4 is also considered as unavailable for NR sidelink transmission.

In some embodiments, when the priority level of the NR sidelink transmission is lower than or equal to a priority level threshold, the UE does not check whether PSFCH-r4 overlaps or partially overlaps with any resource reserved for LTE sidelink transmission. In this case, resource r4 is not excluded according to this resource availability determination.

FIG. 3F illustrates another example for resource availability determination according to some embodiments of the present disclosure.

In FIG. 3F, some parameters are presented as follows:

parameters

| HARQ feedback | enabled | |
|---|---|---|
| SCS for NR V2X | 30 | kHz |
| period of PSFCH | 2 | slots |
| length of a slot for | 1 | ms |
| LTE V2X | | |
| length of a slot for | 0.5 | ms |
| NR V2X | | |

Based on the similar availability determination manner as described above, resource r3 partially overlaps with resource r2′, which is reserved for LTE sidelink transmission, and thus resource r3 is considered as unavailable for NR sidelink transmission.

Resource r4 does not overlap with any resource reserved for LTE sidelink transmission, while the corresponding PSFCH resource, i.e. PSFCH-r4, partially overlaps with resource r1′, which is reserved for LTE sidelink transmission. Therefore, resource r4 is also considered as unavailable for NR sidelink transmission.

In some embodiments, when the priority level of the NR sidelink transmission is lower than or equal to a priority level threshold, the UE does not check whether PSFCH-r4 overlaps or partially overlaps with any resource reserved for LTE sidelink transmission. In this case, resource r4 is not excluded according to this resource availability determination.

FIG. 3G illustrates another example for resource availability determination according to some embodiments of the present disclosure.

In FIG. 3G, some parameters are presented as follows:

parameters

| HARQ feedback | enabled | |
|---|---|---|
| SCS for NR V2X | 30 | kHz |
| period of PSFCH | 4 | slots |
| length of a slot for | 1 | ms |
| LTE V2X | | |
| length of a slot for | 0.5 | ms |
| NR V2X | | |

Based on the similar availability determination manner as described above, resource r3 partially overlaps with resource r2′, which is reserved for LTE sidelink transmission, and thus resource r3 is considered as unavailable for NR sidelink transmission.

Resource r4 does not overlap with any resource reserved for LTE sidelink transmission, while the corresponding PSFCH resource, i.e. PSFCH-r4, partially overlaps with resource r1′, which is reserved for LTE sidelink transmission. Therefore, resource r4 is also considered as unavailable for NR sidelink transmission.

In some embodiments, when the priority level of the NR sidelink transmission is lower than or equal to a priority level threshold, the UE does not check whether PSFCH-r4 overlaps or partially overlaps with any resource reserved for LTE sidelink transmission. In this case, resource r4 is not excluded according to this resource availability determination.

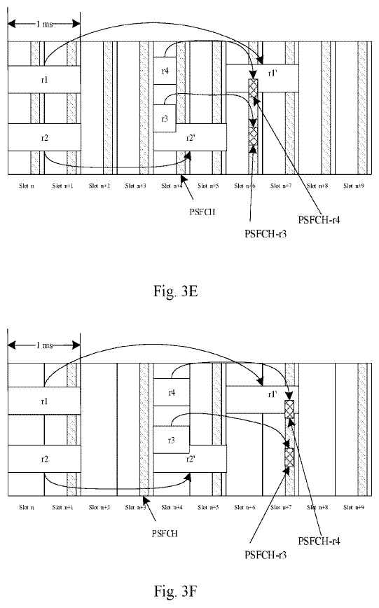

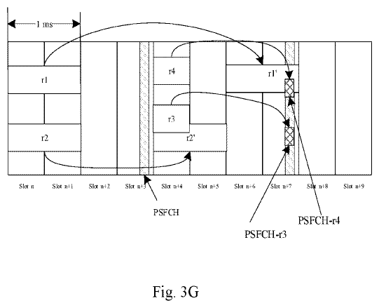

FIG. 4A illustrates an exemplary frame structure for LTE V2X according to some embodiments of the present disclosure. 14 symbols are included in one slot. In particular, 9 symbols of PSSCH, 4 symbols of demodulation reference signal (DMRS), and a symbol of guard interval are included. The guard time or guard interval is the time between the symbols, which is used to prevent inter-symbol interference.

FIG. 4B illustrates an exemplary frame structure for NR V2X according to some embodiments of the present disclosure, which does not include PSFCH. 14 symbols are included in one slot. In particular, a symbol of automatic gain control (AGC), a 2-symbol PSCCH, 10 symbols of PSSCH, 2 symbols of DMRS, and a symbol of guard interval are included.

FIG. 4C illustrates another exemplary frame structure for NR V2X according to some embodiments of the present disclosure, which includes PSFCH. 14 symbols are included in one slot. In particular, a symbol of AGC, a 3-symbol PSCCH, 6 symbols of PSSCH, 3 symbols of DMRS, a symbol of AGC (PSSCH), a symbol of PSFCH, and two symbols of guard intervals are included.

As can be seen, the frame structures for LTE V2X and NR V2X are different, and this might bring AGC issue when LTE V2X and NR V2X are transmitted simultaneously even if they are transmitted on different frequencies.

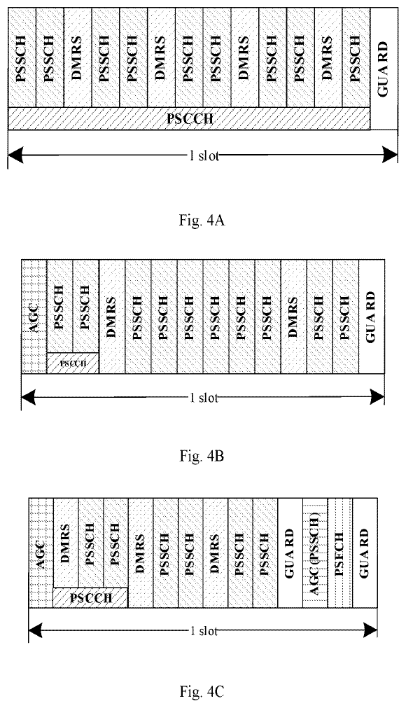

FIGS. 5A-5D illustrate some exemplary frames structures of simultaneous NR V2X and LTE V2X transmissions according to some embodiments of the present disclosure.

In FIG. 5A, the SCS of NR V2X is 15 kHz and no PSFCH resources are configured. That is, the frame structure for LTE V2X is that shown in FIG. 4A, and the frame structure for NR V2X is that shown in FIG. 4B.

For the symbol “GUARD”, it has different gain requirements than other symbols such as PSSCH, PSCCH, etc. As can be seen, the symbol “GUARD” for LTE V2X and that for NR V2X are located at the same position in time domain in FIG. 5A. Therefore, there is no AGC issue in the example shown in FIG. 5A. In the slots where no AGC issue exists, the UE may determine the availability of resource(s) for NR V2X transmission according to the methods described above, for example, with respect to FIGS. 3A-3G.

In FIG. 5B, the SCS of NR V2X is 15 kHz and PSFCH resources are configured. The period of the PSFCH resources is 2 slots. That is, the first slot in FIG. 5B does not include a PSFCH resource, while the second slot in FIG. 5B includes a PSFCH resource.

In the first slot, the frame structure for LTE V2X is that shown in FIG. 4A, and the frame structure for NR V2X is that shown in FIG. 4B. As can be seen, the symbol “GUARD” for LTE V2X and that for NR V2X are located at the same position in the first slot in time domain. Therefore, there is no AGC issue in the first slot of FIG. 5B.

In the second slot, the frame structure for LTE V2X is that shown in FIG. 4A, and the frame structure for NR V2X is that shown in FIG. 4C. As can be seen, at the symbol location marked by the oval, the symbol is “GUARD” in the slot of NR V2X, while the symbol in the slot of LTE V2X is PSSCH. The two symbols have different gain requirements, which may render an AGC issue at this symbol location.

In other scenarios, the SCS of NR V2X is 15 kHz and PSFCH resources are configured, and the period of the PSFCH resources is 1 slot. That is, every slot includes a PSFCH resource, and the frame structure of every slot for NR V2X is that shown in FIG. 4C. In this case, there is an AGC issue in every slot. In still other scenarios, the SCS of NR V2X is 15 kHz and PSFCH resources are configured, and the period of the PSFCH resources is 4 slots. In this case, there is an AGC issue in every four slots, i.e., in the slots including the PSFCH resources.

In the slot where no AGC issue exists, the UE may determine the availability of resource(s) for NR V2X transmission according to the methods as described above, for example, with respect to FIGS. 3A-3G, while in the slot where an AGC issue exists, i.e. there is a PSFCH resource for NR V2X, all resources in that slot are not considered as the candidate resources (i.e., determined as unavailable) for NR V2X transmission when:
1) Any resource in that slot overlaps or partially overlaps with a resource reserved for LTE sidelink transmission, or
2) Any resource in the slot has an associated PSFCH resource overlapping or partially overlapping with a resource reserved for LTE sidelink transmission when HARQ feedback is enabled for NR V2X transmission.

In FIG. 5C, the SCS of NR V2X is 30 kHz, and PSFCH resources are not configured. The length of a slot of LTE V2X is 1 ms, and the length of a slot of NR V2X is 0.5 ms, that is, the length of a slot of LTE V2X is twice of that of NR V2X. The frame structure for LTE V2X is that shown in FIG. 4A, and the frame structure for NR V2X is that shown in FIG. 4B. As can be seen, at the symbol location marked by the oval, the symbol is “GUARD” in the slot of NR V2X, while the symbol in the slot of LTE V2X is PSSCH. The two symbols have different gain requirements, which may render an AGC issue at this symbol location.

Therefore, for NR V2X transmission, all resources in each of these slots are not considered as the candidate resources when:
1) Any resource in that slot overlaps or partially overlaps with a resource reserved for LTE sidelink transmission, or
2) Any resource in the slot has an associated PSFCH resource overlapping or partially overlapping with a resource reserved for LTE sidelink transmission when HARQ feedback is enabled for NR V2X transmission.

In FIG. 5D, the SCS of NR V2X is 30 kHz, and PSFCH resources are configured. The period of the PSFCH resources is 2 slots. The length of a slot of LTE V2X is 1 ms, and the length of a slot of NR V2X is 0.5 ms, that is, the length of a lot of LTE V2X is twice of that of NR V2X.

In the first slot of NR V2X, the frame structure for NR V2X is that shown in FIG. 4B. As can be seen, at the symbol location marked by the oval “ACG issue 1”, the symbol is “GUARD” in the slot of NR V2X, while the symbol in the slot of LTE V2X is PSSCH. The two symbols have different gain requirements, which may render an AGC issue at this symbol location.

In the second slot of NR V2X, the frame structure for NR V2X is that shown in FIG. 4C. As can be seen, at the symbol location marked by the oval “ACG issue 2”, the symbol is “GUARD” in the slot of NR V2X, while the symbol in the slot of LTE V2X is PSSCH. The two symbols have different gain requirements, which may render an AGC issue at this symbol location.

Therefore, for NR V2X transmission, all resources in each of these slots are not considered as the candidate resources when:
1) Any resource in that slot overlaps or partially overlaps with a resource reserved for LTE sidelink transmission, or
2) Any resource in the slot has an associated PSFCH resource overlapping or partially overlapping with a resource reserved for LTE sidelink transmission when HARQ feedback is enabled for NR V2X transmission.

When a UE determines a resource selected or reserved for NR V2X transmission is not available, the UE may perform resource reselection for the NR V2X transmission.

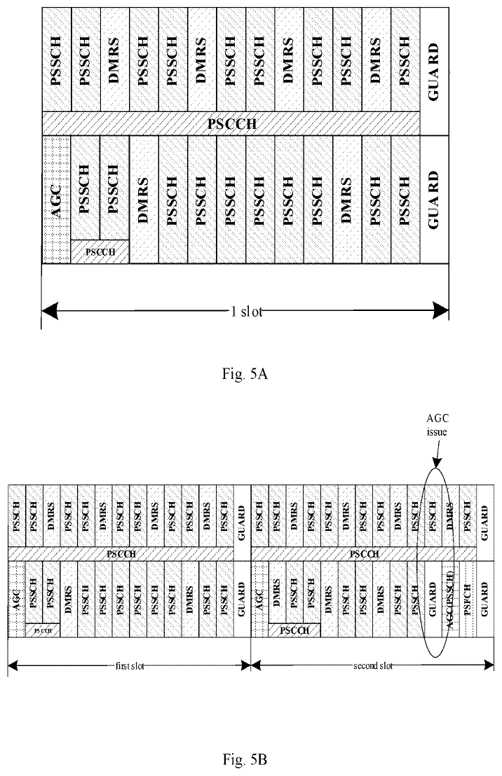

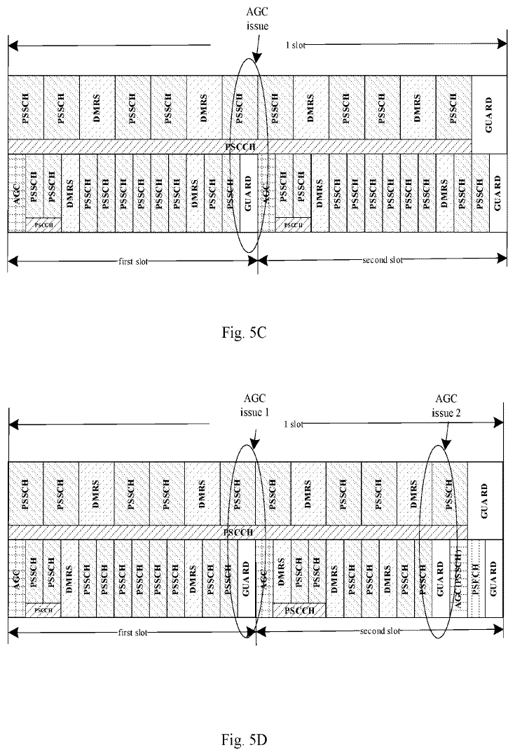

FIG. 6A illustrates an exemplary re-evaluation procedure according to some embodiments of the present discloses.

At time m−T₃, the re-evaluation procedure is triggered. In the case that the resource(s) selected or reserved for NR V2X transmission, for example, any of the resources at m₁, m₂, and m₃, is (are) no longer available (e.g., occupied by LTE V2X transmission), the UE may reselect new resource(s) for NR V2X transmission.

FIG. 6B illustrates an exemplary pre-emption checking procedure according to some embodiments of the present discloses.

At time m−T₃, the pre-emption checking procedure is triggered. In the case that the reserved resource(s) for NR V2X transmission, for example, the resource at m, is (are) no longer available (e.g., occupied by LTE V2X transmission), the UE may reselect new resource(s) for NR V2X transmission.

When the selected or reserved resource for NR V2X transmission is under the scenario as shown in FIG. 5A, the UE may reselect a new resource if the selected or reserved resource has been reserved for LTE sidelink transmission, or the PSFCH resource corresponding to the selected or reserved resource has been reserved for LTE sidelink transmission when HARQ feedback is enabled for NR sidelink transmission.

When the selected or reserved resource for NR V2X transmission is under the scenario as shown in FIG. 5B, if there is no configured PSFCH resources in that slot where the selected or reserved resource is located, the UE may reselect a new resource if the selected or reserved resource has been reserved for LTE sidelink transmission, or the associated PSFCH resource has been reserved for LTE sidelink transmission when HARQ feedback is enabled for NR sidelink transmission; if there are configured PSFCH resources in that slot, the UE may reselect a new resource if any resource in that slot has been reserved for LTE sidelink transmission, or any resource in that slot has an associated PSFCH resource which has been reserved for LTE sidelink transmission when HARQ feedback is enabled for NR sidelink transmission.

When the selected or reserved resource for NR V2X transmission is under the scenarios as shown in FIGS. 5C and 5D, the UE may reselect a new resource if any resource in that slot where the selected or reserved resource is located has been reserved for LTE sidelink transmission, or any resource in that slot has an associated PSFCH resource which has been reserved for LTE sidelink transmission when HARQ feedback is enabled for NR sidelink transmission.

V2X in-device coexistence has been designed for inter-band and adjacent channels. For dynamic in-device coexistence, a UE may select one for reception or transmission based on the priorities of LTE V2X and NR V2X, e.g.,
1) LTE V2X transmission and NR V2X transmission; or
2) LTE V2X transmission or reception and NR V2X reception.

For co-channel coexistence, the present disclosure proposes the following solutions:
(1) For LTE V2X transmission and NR V2X reception or transmission that would overlap, when the UE is aware that other LTE V2X UE has reserved the overlapped resource, the UE may perform LTE V2X transmission without NR V2X reception or transmission.
(2) For LTE V2X reception and NR V2X reception or transmission that would overlap, the UE may perform LTE V2X reception without NR V2X reception or transmission.

According to some embodiments of the present disclosure, for co-channel coexistence of LTE V2X and NR V2X, there should be in-device coordination between LTE V2X module and NR V2X module, e.g., the LTE V2X module informs its sensing result to the NR V2X module via in-device coordination.

According to some embodiments of the present disclosure, due to different sensing parameters between LTE V2X and NR V2X, e.g., different priorities or different reference signal received power (RSRP) thresholds, the LTE V2X module and the NR V2X module may also coordinate the sensing parameters. For example, two methods are proposed as follows:
(1) The NR V2X module informs its sensing parameters to the LTE V2X module, and the LTE V2X module performs sensing based on the received sensing parameters and then informs the sensing results to the NR V2X module.
(2) The LTE V2X module performs sensing based on its own sensing parameters, and then informs the sensing results and sensing parameters to the NR V2X module.

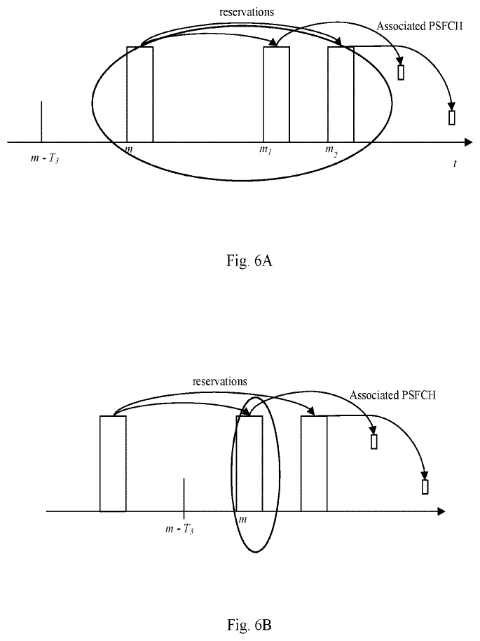

FIG. 7 illustrates a simplified block diagram of an exemplary apparatus 700 according to some embodiments of the subject disclosure. The apparatus 700 may be or include at least part of a UE or a device with similar functions.

The apparatus 700 may include a processor, which is configured to perform any of the methods described in the present disclosure, for example, the methods described with respect to FIGS. 3A-3G and 5A-6B. For example, the processor is configured to determine availability of one or more resources for a first sidelink transmission associated with a first RAT based on at least one of: information on one or more reserved resources for second sidelink transmission(s) associated with a second RAT; information on one or more PSFCH resources corresponding to the one or more resources; a priority level of the first sidelink transmission; a first sub-carrier spacing of the first RAT; and a first frame structure for the first RAT in one or more slots where the one or more resources are located. For example, the processor may be configured to determine whether the resource r3 is available for the NR sidelink transmission based on whether the resource r3 is reserved for LTE sidelink transmission, as shown in FIG. 3A.

In some other embodiments, the processor may be configured to perform any of the methods described in the present disclosure by executing instructions stored on a non-transitory machine-readable medium.

The apparatus 700 may further include a transceiver, which is coupled to the processor. In some embodiments of the present disclosure, the transceiver is configured to not perform the first sidelink transmission with at least one resource determined as unavailable for the first sidelink transmission.

In some embodiments, in order to determine the availability of the one or more resources, the processor is configured to: determine a first resource of the one or more resources as unavailable for the first sidelink transmission when the first resource at least partially overlaps with any of the one or more reserved resources associated with the second RAT in both time domain and frequency domain or a PSFCH resource corresponding to the first resource at least partially overlaps with any of the one or more reserved resources associated with the second RAT in both time domain and frequency domain.

For example, as shown in FIG. 3B, the processor may be configured to determine resource r3 as unavailable for NR sidelink transmission because resource r3 overlaps with resource r2′, which is reserved for LTE sidelink transmission. The processor may be configured to determine resource r4 as unavailable for NR sidelink transmission because the corresponding PSFCH resource, i.e. PSFCH-r4, overlaps with resource r1′.

In some embodiments, in order to determine the availability of the one or more resources, the processor is configured to: in the case that the priority level of the first sidelink transmission is higher than a configured level, determine a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both time domain and frequency domain; and in the case that the priority level of the first sidelink transmission is lower than or equal to the configured level, determine the first resource as unavailable for the first sidelink transmission when the first resource at least partially overlaps with any of the one or more reserved resources associated with the second RAT in both time domain and frequency domain.

In some embodiments, in order to determine the availability of the one or more resources, the processor is configured to: determine a first resource of the one or more resources as unavailable for the first sidelink transmission when any resource in the slot in which the first resource is located or a PSFCH resource corresponding to any resource in the slot in which the first resource is located is reserved for the second sidelink transmission(s) associated with the second RAT.

In some embodiments, the processor is further configured to: select a resource from resource(s) determined as available for the first sidelink transmission; determine whether the selected resource is available based on information on one or more reserved resources for sidelink transmission(s) associated with the second RAT; and perform resource reselection when the selected resource is determined as unavailable.

In some embodiments, the selected resource is determined as unavailable when the selected resource at least partially overlaps with any of the one or more reserved resources in both time domain and frequency domain, and/or a PSFCH resource corresponding to the selected resource at least partially overlaps with any of the one or more reserved resources in both time domain and frequency domain.

In some other embodiments, the selected resource is determined as unavailable when any resource in the slot in which the selected resource is located or a PSFCH resource corresponding to any resource in the slot in which the selected resource is located is reserved for the sidelink transmission(s) associated with the second RAT.

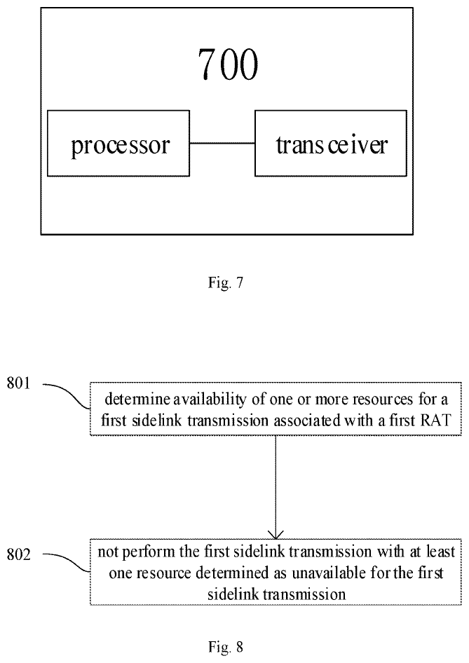

FIG. 8 illustrates a flow chart of an exemplary method according to some embodiments of the subject disclosure. Although the method is described with respect to a UE below, it is contemplated that the method can be performed by other device with similar functions.

In step 801, the UE determines availability of one or more resources for a first sidelink transmission associated with a first RAT. In some embodiments of the present disclosure, the availability is determined based on at least one of: information on one or more reserved resources for second sidelink transmission(s) associated with a second RAT; information on one or more PSFCH resources corresponding to the one or more resources; a priority level of the first sidelink transmission; a first sub-carrier spacing of the first RAT; and a first frame structure for the first RAT in one or more slots where the one or more resources are located. For example, as shown in FIG. 3A, the UE may determine whether the resource r3 is available for the NR sidelink transmission based on whether the resource r3 is reserved for LTE sidelink transmission.

In step 802, the UE does not perform the first sidelink transmission with at least one resource determined as unavailable for the first sidelink transmission. Specifically, the UE excludes the at least one resource determined as unavailable from candidate resource(s) for the first sidelink transmission.

It is contemplated that the method illustrated in FIG. 8 may include other steps not shown, for example, any steps described with respect to FIGS. 3A-3G and 5A-6B.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
determine availability of one or more resources for a first sidelink transmission associated with a first radio access technology (RAT) based on at least one of:
first information on one or more reserved resources for one or more second sidelink transmissions associated with a second RAT;
second information on one or more physical sidelink feedback channel (PSFCH) resources corresponding to the one or more resources;
a priority level of the first sidelink transmission;
a first sub-carrier spacing of the first RAT; or
a first frame structure for the first RAT in one or more slots where the one or more resources are located; and
not perform the first sidelink transmission based on at least one resource determined as unavailable for the first sidelink transmission.

2. The UE of claim 1, wherein, to determine the availability of the one or more resources, the at least one processor is configured to cause the UE to:
determine a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both the time domain and the frequency domain.

3. The UE of claim 1, wherein, to determine the availability of the one or more resources, the at least one processor is configured to cause the UE to:
if the priority level of the first sidelink transmission is higher than a configured level, determine a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both the time domain and the frequency domain; and
if the priority level of the first sidelink transmission is lower than or equal to the configured level, determine the first resource as unavailable for the first sidelink transmission when the first resource at least partially overlaps with any of the one or more reserved resources associated with the second RAT in both the time domain and the frequency domain.

4. The UE of claim 1, wherein, to determine the availability of the one or more resources, the at least one processor is configured to cause the UE to:
determine a first resource of the one or more resources as unavailable for the first sidelink transmission when any resource in a slot in which the first resource is located or a PSFCH resource corresponding to any resource in the slot in which the first resource is located is reserved for the one or more second sidelink transmissions associated with the second RAT.

5. The UE of claim 1, wherein the at least one processor is configured to cause the UE to:
select a resource from the one or more resources determined as available for the first sidelink transmission;
determine whether the selected resource is available based on information on the one or more reserved resources for the one or more second sidelink transmissions associated with the second RAT; and
perform resource reselection when the selected resource is determined as unavailable.

6. The UE of claim 5, wherein the selected resource is determined as unavailable if at least one of the selected resource at least partially overlaps with any of the one or more reserved resources in both time domain and frequency domain, or a PSFCH resource corresponding to the selected resource at least partially overlaps with any of the one or more reserved resources in both the time domain and the frequency domain.

7. The UE of claim 5, wherein the selected resource is determined as unavailable when any resource in a slot in which the selected resource is located or a PSFCH resource corresponding to any resource in the slot in which the selected resource is located is reserved for the one or more second sidelink transmissions associated with the second RAT.

8. A method performed by a user equipment (UE), the method comprising:
determining availability of one or more resources for a first sidelink transmission associated with a first radio access technology (RAT) based on at least one of:
first information on one or more reserved resources for one or more second sidelink transmissions associated with a second RAT;
second information on one or more physical sidelink feedback channel (PSFCH) resources corresponding to the one or more resources;
a priority level of the first sidelink transmission;
a first sub-carrier spacing of the first RAT; or
a first frame structure for the first RAT in one or more slots where the one or more resources are located; and
not performing the first sidelink transmission based on at least one resource determined as unavailable for the first sidelink transmission.

9. The method of claim 8, wherein determining the availability of the one or more resources comprises:
determining a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both the time domain and the frequency domain.

10. The method of claim 8, wherein determining the availability of the one or more resources comprises:
if the priority level of the first sidelink transmission is higher than a configured level, determining a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both the time domain and the frequency domain; and
if the priority level of the first sidelink transmission is lower than or equal to the configured level, determining the first resource as unavailable for the first sidelink transmission when the first resource at least partially overlaps with any of the one or more reserved resources associated with the second RAT in both the time domain and the frequency domain.

11. The method of claim 8, wherein determining the availability of the one or more resources comprises:
determining a first resource of the one or more resources as unavailable for the first sidelink transmission when any resource in a slot in which the first resource is located or a PSFCH resource corresponding to any resource in the slot in which the first resource is located is reserved for the one or more second sidelink transmissions associated with the second RAT.

12. The method of claim 8, further comprising:
selecting a resource from the one or more resources determined as available for the first sidelink transmission;
determining whether the selected resource is available based on information on the one or more reserved resources for the one or more second sidelink transmissions associated with the second RAT; and
performing resource reselection when the selected resource is determined as unavailable.

13. The method of claim 12, wherein the selected resource is determined as unavailable if at least one of the selected resource at least partially overlaps with any of the one or more reserved resources in both time domain and frequency domain, or a PSFCH resource corresponding to the selected resource at least partially overlaps with any of the one or more reserved resources in both the time domain and the frequency domain.

14. The method of claim 12, wherein the selected resource is determined as unavailable when any resource in a slot in which the selected resource is located or a PSFCH resource corresponding to any resource in the slot in which the selected resource is located is reserved for the one or more second sidelink transmissions associated with the second RAT.

15. A processor for wireless communication, comprising:
at least one controller coupled with at least one memory and configured to cause the processor to:
determine availability of one or more resources for a first sidelink transmission associated with a first radio access technology (RAT) based on at least one of:
first information on one or more reserved resources for one or more second sidelink transmissions associated with a second RAT;
second information on one or more physical sidelink feedback channel (PSFCH) resources corresponding to the one or more resources;
a priority level of the first sidelink transmission;
a first sub-carrier spacing of the first RAT; or
a first frame structure for the first RAT in one or more slots where the one or more resources are located; and
not perform the first sidelink transmission based on at least one resource determined as unavailable for the first sidelink transmission.

16. The processor of claim 15, wherein to determine the availability of the one or more resources, the at least one controller is configured to cause the processor to:
determine a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both the time domain and the frequency domain.

17. The processor of claim 15, wherein to determine the availability of the one or more resources, the at least one controller is configured to cause the processor to:
if the priority level of the first sidelink transmission is higher than a configured level, determine a first resource of the one or more resources as unavailable for the first sidelink transmission when the first resource at least partially overlaps with any of the one or more reserved resources associated with the second RAT in both time domain and frequency domain, or a PSFCH resource corresponding to the first resource at least partially overlaps with any of the one or more reserved resources associated with the second RAT in both the time domain and the frequency domain; and
if the priority level of the first sidelink transmission is lower than or equal to the configured level, determine the first resource as unavailable for the first sidelink transmission when the first resource at least partially overlaps with any of the one or more reserved resources associated with the second RAT in both the time domain and the frequency domain.

18. The processor of claim 15, wherein to determine the availability of the one or more resources, the at least one controller is configured to cause the processor to:
determine a first resource of the one or more resources as unavailable for the first sidelink transmission when any resource in a slot in which the first resource is located or a PSFCH resource corresponding to any resource in the slot in which the first resource is located is reserved for the one or more second sidelink transmissions associated with the second RAT.

19. The processor of claim 15, wherein the at least one controller is configured to cause the processor to:
select a resource from the one or more resources determined as available for the first sidelink transmission;
determine whether the selected resource is available based on information on the one or more reserved resources for the one or more second sidelink transmissions associated with the second RAT; and
perform resource reselection when the selected resource is determined as unavailable.

20. The processor of claim 19, wherein the selected resource is determined as unavailable if at least one of the selected resource at least partially overlaps with any of the one or more reserved resources in both time domain and frequency domain, or a PSFCH resource corresponding to the selected resource at least partially overlaps with any of the one or more reserved resources in both the time domain and the frequency domain.
